(19) United States
(12) Patent Application Publication
(10) Pub. No.: US 2010/0256251 A1
(43) Pub. Date: Oct. 7, 2010

(54) PROCESS FOR MODIFYING SUBSTRATES WITH GRAFTED POLYMERS

(76) Inventors: Daniel J. Dyer, Carbondale, IL (US); Rolf Schmidt, Montreal (CA); Tongfeng Zhao, Exton, PA (US); Yusuf Yagci, Istanbul (TR); Jianxin Feng, South Hadley, MA (US)

Correspondence Address: Bryan K. Wheelock, Suite 400, 7700 Bonhomme, St. Louis, MO, 63105, US

(21) Appl. No.: 12/718,952

(22) Filed: Mar. 5, 2010

Related U.S. Application Data
(63) Continuation of application No. 11/200,874, filed on Aug. 10, 2005, now abandoned.
(60) Provisional application No. 60/601,744, filed on Aug. 13, 2004.

(51) Int. Cl. C08F 2/50; C08F 2/46

(52) U.S. Cl. 522/46; 522/173; 522/63; 977/773

(57) ABSTRACT

The present invention relates to a chemical process for modifying inorganic and organic substrates with thin polymer films that are grafted to a substrate. The preferred composition includes a dimethylamino terminated precursor that is deposited as a self-assembled monolayer onto a gold or silicon oxide, or other substrate. The polymerization is then initiated by irradiation with UV light in the presence of monomer and an optional photosensitizer.

### CROSS-REFERENCE TO RELATED APPLICATIONS

This application claims the benefit of U.S. Provisional Application No. 60/601,744, filed on Aug. 13, 2004. The disclosure of the above application is incorporated herein by reference.

### FIELD OF THE INVENTION

This invention relates to a chemical process for modifying inorganic and organic substrates with thin polymer films.

### BACKGROUND OF THE INVENTION

When polymer chains are tethered to an interface, they may stretch out away from that interface, such films are called “polymer brushes”. Polymer brushes offer a unique approach to the synthesis of well-defined structures with controlled functionality on the nanometer scale. These organic films will impact a variety of fields including biomaterials for tissue engineering, drug delivery, implants and cell adhesion, and protein recognition. Other areas include adhesion and wetting, microfluidics, nanofluidics, microfabrication, nanofabrication, molecular recognition, chemical sensing, and organic synthesis. Inorganic and organic substrates can be modified with organic polymers by a variety of techniques. In particular, “grafting-from” (GF) strategies, or surface initiated polymerization (SIP), offer distinct advantages over alternative modes of deposition such as spin casting or the “grafting-to” (GT) approach (FIG. 1) For instance, a cast film is merely adsorbed, or physisorbed, to a surface and may de-adsorb under various conditions, particularly in a good solvent for the polymer. Polymers that are grafted, or chemisorbed, to a substrate are more robust and may stretch away from the substrate when the grafting density is sufficiently high. However, the GT technique typically yields low-density polymer brushes because, once grafted, the chains inhibit diffusion of additional reactive polymers to the active functional groups at the surface (FIG. 1b). In contrast, the GF technique utilizes a polymer initiator that is covalently linked to the surface by a self-assembled monolayer (SAM) so that the polymer grows out away from the substrate and always remains tethered (FIG. 1c). Where GT films are typically less than 10 nm thick, GF films may span a broad range from a few nanometers to greater than one micron.

It has also been shown that one can graft a monomer from a monomer vapor to a substrate in the presence of a photosensitizer. Ranby, B. International Journal of Adhesion & Adhesives 1999, 19, 337-343, and references therein, the disclosures of each of which are incorporated herein.

Polymer brushes have been synthesized by a variety of initiating mechanisms including anionic, cationic, ring-opening (ROP), ring-opening metathesis (ROMP), free radical, controlled radical, enzymatic, and organometallic catalysts. Radical polymerizations are preferred for many applications due to a tolerance for moisture, and a wide variety of organic functional groups. These grafting methods are well-known to those skilled in the art and are disclosed in: a) European Patent 1035218; b) J. Rühe, W. Knoll, J. Macromol. Sci.: Polym. Rev. 2002, C42, 91-138; c) B. Zhao, W. J. Brittain, Prog. Polym. Sci. 2000, 25, 677-710; d) Y. Nagasaki, K. Kataoka, Trends Polym. Sci. 1996, 4, 59-64; e) S. Edmondson, V. L. Osborne, W. T. S. Huck Chem. Soc. Rev. 2004, 33, 14-22; f) J. Pyun, T. Kowalewski, K. Matyjaszewski Macromol. Rapid. Commun. 2003, 24, 1043-1059; g) S. T. Milner, Science 1991, 251, 905-914, the disclosures of each of which are incorporated herein by reference.

Photochemical initiated free radical polymerizations are particularly useful since they may be performed under a diverse range of reaction conditions. For instance, at various temperatures and/or with different solvent concentrations; where initiation is controlled by irradiation with ultraviolet light. The photochemical synthesis of grafted polymers by GF techniques has been disclosed by Dyer, D. J.; Feng, J.; Fivelson, C.; Paul, R.; Schmidt, R.; Zhao, T. In Polymer Brushes; Advincula, R. C., Brittain, W., Caster, K., Rühe, J., Eds.; Wiley-VCH: New York, 2004; Chp. 7, p. 129, and references therein, the disclosures of each of which are incorporated herein by reference. A particular advantage to photoinitiation from self-assembled monolayers is the ability to pattern substrates as disclosed in Dyer, D. J. Adv. Fund. Mater. 2003, 13, 667-670, and references therein the disclosures of each of which are incorporated herein by reference. Furthermore, grafting from polymer substrates, such as polyolefins has been described where photosensitizers, such as benzophenone, are used to create free radicals on thin polymer films as disclosed in Zhang, P. Y.; Ranby, B. J. Appl. Polym. Sci. 1990, 40, 1647-1661, and references therein the disclosures of each of which are incorporated herein by reference.

It is also well-known in the photocuring field that tertiary amines may accelerate the polymerization of acrylates and methacrylates. These amino functionalities may be activated by singlet oxygen or triplet sensitizers, such as benzophenone. The sensitizer may also consist of a two-photon absorbing species such as Rose Bengal as disclosed in Pitts, J. D.: Campagnola, P. J.; Eppling, G. A.; Goodman, S. L. Macromolecules 2000, 33, 1514-1523 and Campagnola, P. J.; Delguidice, D. M.; Epling, G. A.; Hoffacker, K. D.; Howell, A. R.; Pitts, J. D.; Goodman, S. L. Macromolecules 2000, 33, 1511-1513, and references therein the disclosures of which are incorporated herein by reference. In these cases a photo-excited sensitizer abstracts a hydrogen from a carbon adjacent to the amine; thus, generating a radical, which then initiates the polymerization of monomer. There are numerous reports in the literature of initiating systems that contain amine functionalities and some representative examples are disclosed here: a) Yagci, Y. Macromol. Symp. 2000, 161, 19-35; b) Davidson, R. S. In Radiation Curing in Polymer Science and Technology: Polymerisation Mechanisms; J. P. Fouassier, J. F. Rabek, Eds.; Elsevier: New York, 1993; Vol. III, Chapter 5; c) Nguyen, C. K.; Cavitt, T. B.; Hoyle, C. E.; Kalyanaraman, V.; Jöhsson, S. In Photoinitiated Polymerization; K. D. Belfield, J. V. Crivello, Eds.; ACS Symposium Series 847; American Chemical Society: Washington, D.C., 2003; Chapter 3; d) Fouassier, J. P. Rapra Rev. Rep. 1998, 9(4), 3-23; e) Li, T. Polym. Bull. 1990, 24, 397-404; f) Davidson, R. S.; Goodin, J. W. Eur. Polym. J. 1982, 18, 597-606; g) Japanese patent 2003156842; h) Japanese patent 2003029403; i) Japanese patent 2002356505; j) Japanese patent 10153862; and k) Japanese patent 09244243, the disclosures of each of which are incorporated herein by reference.

It is generally accepted that a photosensitizer must be present in order for the amine to initiate the polymerization. However, it has been suggested that methylmethacrylate, a monomer, may form a photo-excited complex with triethylamine, as disclosed in R. Sato, T. Kurihara, M. Takeishi Polymer International 1998, 47, 159-164, and references therein, the disclosures of each of which are incorporated herein by reference. Importantly, these amine initiating systems have not been applied to OF techniques, nor has it been disclosed that amine containing SAMs are efficient free radical initiators. Therefore, it is an object of the present invention to utilize amino containing compounds to initiate the synthesis of polymers that are grafted to various substrates.

Other objects and advantages will become apparent from the following disclosure.

### SUMMARY OF THE INVENTION

In accordance with one embodiment of this invention a photoinitiator strategy is used to synthesize grafted polymer films. The inventors have successfully prepared dimethylamino terminated monolayers as initiators for the growth of polystyrene and polymethylmethacrylate on gold substrates. Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1 is a schematic diagram of various approaches for modifying inorganic substrates with organic polymers;

FIG. 2 is a graph of reaction time versus PS brush thickness: (a) an AIBN type initiating SAM; (b) a SAM of compound 2; and (c) a SAM of compound 2 with trace amounts of air.

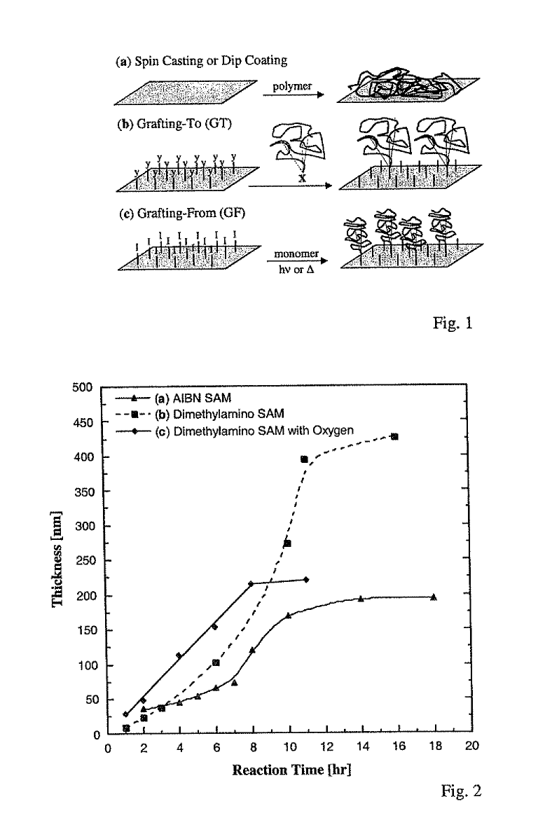

### DETAILED DESCRIPTION OF THE PREFERRED EMBODIMENTS

The present invention relates to a thin organic polymer films synthesized by a photochemical initiator bound to a substrate. A feature of this invention is the use of a dimethylamino terminated initiator for the synthesis of such films. A preferred class of the compounds of the present invention has the following “formula 1”, including derivatives thereof and referred to herein as alkylamino initiators:

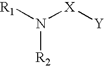

wherein R1 and R2 consist of any combination of hydrogen, methyl, (C₁-C₂₀) alkyl, C₁-C₂₀ perfluoroalkyl, amide, imide, ester, carbamate, ((CH₂)ₘOCₙH₂ₙ), (O(CₙH₂ₙ₊₁), or hydroxyl. Furthermore, X may consist of (C₁-C₂₀)alkyl, ((CH₂)ₘOCₙH₂ₙ)alkoxy, (C₁-C₂₀)perfluoroalkyl, ((CH₂)OCₙF₂ₙ)perfluoroalkoxy, aryl, or any combination thereof. In addition, carbonyl functionalities, such as esters, imides and carbamates may be incorporated into X. Finally, Y may consist of thiol, disulfides, trialkoxysilyl, dimethylalkoxysilyl, dimethylchlorosilyl, trichiorosilyl, phosphate, phosphine oxide, or any monomeric unit such as acrylate, methacrylate, or vinyl for incorporation into a polymer prior to photografting.

A variety of substrates are available for use as surfaces for the polymerization. Suitable substrates consist of surfaces such as silver and gold including microparticles or nanoparticles thereof. In addition, other surfaces may be utilized including silicon wafers, silicon oxide glass, mica, quartz, silica gel, and silica microparticles or nanoparticles. Also, the polymerization may be carried out from organic polymer films such as, but not limited to, polystyrene, polyacrylates, polymethacrylates, and polyolefins. The polymerization may also be perfomed on Cd/Se nanoparticles. Furthermore, biopolymers or membranes are suitable for use as a substrate for the polymerization, as are hyperbranched polymers, such as dendrimers.

As a representative sample, not intended to limit the scope of the invention, a series of dimethylamino terminated thiols and disulfides were designed. Initially, formula 1 was used to develop compound 1.

(CH₃)₂N—(CH₂)₁₆—SH “compound ”

Also, additional monomers were formed consisting of two dimethyiamino terminating groups with disulfanyl alkanes and esters embodied in the compound. The monomer comprises a compound represented by formula 2 wherein Z is an alkyl group.

(CH₃)₂N—(CH₂)₃—OOC—Z—S—S—Z—COO—(CH₂)₃—N(CH₃)₂ “formula 2”

Formula 2 was used to develop compound 2.

(CH₃)₂N—(CH₂)₃—OOC—(CH₂)₁₅—S—S—(CH₂)₁₅—COO—(CH₂)₃—N(CH₃)₂ “compound 2”

Another compound with disulfanyl alkanes and esters embodied but with a methyl terminus in lieu of a dialkylamino terminus was designed as a control and is represented as compound 3.

CH₃—(CH₂)₃—OOC—(CH₂)₁₅—S—S—(CH₂)₁₅—COO—(CH₂)₃—CH₃ “compound 3”

Compound 1 formed highly crystalline and densely packed monolayers of approximately 2 nm, which is very near the calculated length of the molecule in the gas phase. Upon polymerization with neat styrene and benzophenone, polystyrene (PS) was clearly evident by reflection absorption infrared spectroscopy (RAIRS) and the static water contact angle was consistent with PS at 88°. An optical thickness of 140±0.6 nm was obtained using data from ellipsometry. PS was also found in the bulk solution, which is expected under these conditions as styrene is known to autopolymerize. The bulk polymer, along with residual physisorbed polymer is removed by solvent extraction.

Compound 1 as an initiator SAM was also studied in the absence of benzophenone. In this case, the thickness increased to 202±3 nm. Thus, the films were actually thicker in the absence of the photosensitizer.

We also examined SAMs of compound 2, which yielded a grafted PS film of 150±2 nm upon only 6 hours of irradiation without photosensitizer, while the substrate with compound 3 did not contain polymer. Therefore, it is evident that the dimethylamino group is necessary for polymerization and the internal ester does not play an active role.

FIG. 2 describes the growth kinetics of polystyrene films from SAM coated gold substrates with two different initiators. In particular, FIG. 2a describes a SAM composed of an initiator based on azo-bis-isobutyronitrile (AIBN) that was developed in our laboratory and is disclosed in the following articles: 1) Paul, R.; Schmidt, R.; Feng, J.; Dyer, D. J. J. Polym. Sci: Part A; Polym. Chem. 2002, 40, 3284-3291; and 2) Schmidt, R.; Zhao, T.; Green, J.-B.; Dyer, D. J. Langmuir 2002, 18, 1281-1287, the disclosures of each of which are incorporated herein by reference. This photoinitiating system is the state-of-the-art and represents the fastest polymerization rate for PS of all known grafting-from initiating systems to date. As is clearly illustrated in FIG. 2b, the dimethylamino initiator (compound 2) is superior in two respects: First, it yields a maximum thickness of approximately 450 nm compared to 200 nm for the AIBN system. Second, the rate of film growth is improved significantly as illustrated in a steeper slope.

A surprising aspect of this initiating system is illustrated in FIG. 2c, which is from an identical SAM as that in FIG. 2b. The difference lies in the experimental procedures where residual oxygen from the air was leaked into the reaction chamber for FIG. 2c but not for FIG. 2b. The residual oxygen had a dramatic effect on the reaction kinetics manifested in rapid termination after only eight hours at approximately 220 nm. More importantly, the rate of film growth was at least 3 times greater with residual oxygen in the early stages of the polymerization. Furthermore, the thickness increased linearly, which is more desirable for applications that require precise control of film thickness. Thus, there are many parameters that may be used to fine-tune the reactivity of these SAMs.

Polymerization of poly(methylmethacrylate) was also tested with compound 2 as a SAM initiator. A solution polymerization with toluene yielded a PMMA brush of 675±8 nm after 15 hours. For PMMA, the addition of benzophenone reduced the thickness by more than half, with the brush being 250±3 nm thick.

The following examples describe certain compositions of the present invention. The detailed description falls within the scope, and serves to exemplify the more general descriptions set forth above. These examples are presented for illustrative purposes only, and are not intended as restrictions on the scope of the invention.

### EXAMPLE 1

Step 1. To a mixture of 30 ml dichloromethane and 1.0 g 16-Mercapto-hexanoic acid, 5 ml acetyl chloride was added, followed by reflux for 5 hours under argon. Upon cooling to room temperature, 100 ml water was added, and the mixture was stirred for 1 hour. Dichloromethane was then added, and the organic and aqueous layers were separated. Anhydrous magnesium sulfate was added to the organic layer, followed by filtration. The filtrate was concentrated and subjected to column chromatography using dichloromethane as the eluant. Vacuum evaporation of the solvent yielded 910 mg (79%) of 16-Acetylsulfanyl-hexadecanoic acid as a white solid.

The above compound has been previously synthesized; Svedhem, D.; Hollander, C.; Schi, J.; Konradsson, P.; Liedberg, B.; Svensson, S. C. T. J. Org. Chem. 2001, 66, 4494-4503, the disclosures of each of which are incorporated herein by reference.

Step 2. To 30 ml of dichloromethane containing 16-Acetylsulfanyl-hexadecanoic acid, a mixture of 10 ml dichloromethane and 1.0 g of oxalyl chloride was slowly added. The reaction was refluxed for one hour under argon prior to solvent evaporation. The crude acid chloride was dissolved in 15 ml of dry tetrahydrofuran, which was carefully added over 30 minutes to a stirred solution of 2.0 g dimethylamine hydrochloride and 2.0 g potassium carbonate in 15 ml dry tetrahydrofuran, followed by reflux for 1 hour under argon. The mixture was then cooled to room temperature and poured into 100 ml water. The solution was then extracted twice with 80 ml portions of dichloromethane. The combined organic layers were washed with water and dried over anhydrous magnesium sulfate. Vacuum evaporation yielded 430 mg (100%) of 16-Acetylsulfanyl-hexadecanoic acid dimethylamide as a white solid. The crude was taken on without purification.

Step 3. To 40 ml of dry tetrahydrofuran solution containing 433 mg 16-Acetylsulfanyl-hexadecanoic acid dimethylamide at 0° C., 800 mg of lithium aluminum hydride was added. The reaction mixture was stirred under argon for 4 hours at room temperature followed by the addition of 100 ml ice water. The aqueous solution was adjusted to pH 7 with 10% hydrochloric acid. The organic layer was dried over anhydrous magnesium sulfate, and subjected to filtration. The organic filtrate was subjected to column chromatography utilizing a 90:10 ratio of dichloromethane and methanol as the eluant. Vacuum evaporation yielded 130 mg (36%) of 16-N,N-dimethylamino-1-mercaptohexadecane (compound 1) as a white solid. R_{F}=0.46 (90:10-CH₂Cl₂:MeOH); ¹H NMR (300 MHz, CDCl₃) δ 1.20-1.45 (m,24H), 1.60-1.85 (m, 4H), 2.65 (t, J=7.3 Hz, 1H), 2.73 (s, 6H). 2.90 (m, 4H); ¹³C NMR (75 MHz, CDCl₃) δ 24.61, 27.49, 27.80, 28.35, 29.04, 29.48, 29.56 (2C), 29.60 (3C), 29.62 (3C), 34.02, 45.52 (2C), 59.97; FT-IR (neat) 2924, 2852, 2812, 2762, 1464, 1263, 1041 cm⁻¹; MS (EI+) 301.3 (57.0, 69.1); Calculated for C₁₈H₃₉NS=301.2803, found 301.2797.

### EXAMPLE 2

500 mg of 3-Carboxypropyl disulfide was combined with 10 ml thionyl chloride, followed by reflux for 20 minutes under argon at 90° C. Excess thionyl chloride was removed via vacuum to obtain 4-(4-Chloro-3-oxo-butyldisulfanyl)-butyryl chloride. Before the flask was allowed to cool, 5 ml of 3-dimethylamino-1-propanol was immediately poured into the flask. The flask was stirred at 100° C. for 30 minutes under argon. 3-dimethylamino-1-propanol was evaporated at 120° C. Then, 60 ml of chloroform was added and the solution was washed three times with 40 ml portions of water. The layers were separated, and carbon was added to the organic layer, followed by filtration. The filtrate was concentrated and subjected to column chromatography on alumina with ethyl acetate as the eluting solvent. Vacuum evaporation yielded 300 mg (32%) of compound 2 as a clear oil. R_{F} 0.23(ethyl acetate, alumina TLC plate); ¹H NMR (300 MHz, CDCl₃): δ 1.75 (m,4H), 1.98 (m, 4H), 2.18 (s,12H), 2.29 (t, J=7.5 Hz, 4H), 2.39 (t, J=7.3 Hz, 8H), 2.67 (t,J=7.1 Hz, 4H), 4.08(t, J=6.6 Hz, 4H); ¹³C NMR (75 MHz, CDCl₃): δ 24.38 (2C), 27.17 (2C), 32.78 (2C), 38.00 (2C), 45.69 (4C), 56.43 (2C), 63.09 (2C), 76.83 (2C), 173.13 (20); FT-IR (neat): 2946, 2816, 2765, 1736, 1454, 1202, 1135 cm⁻¹; MS(FAB+) m/z: 409.2(745.6, 705.5, 371.3, 309.0, 206.1, 155.0); Anal Calc'd for C₁₈H₃₆N₂O₄S₂: C, 52.91, H, 8.88, N, 6.86, S, 15.69; found: C, 52.48, H, 8.21, N, 6.75, S, 16.13.

By employing the same synthesis methods, the above mentioned compound 3,4-[4-(3-Dimethylamino-propoxy)-3-oxo-butyldisulfanyl]-butyric acid 3-dimethylamino-propyl ester, was obtained.

Depositions of gold films were performed in an Edwards E13E vacuum evaporator equipped with a Leybold Inficon QCM film-thickness monitor. The gold substrates were all formed on single-crystal silicon wafers <100>. The wafers were used as received, blown off with liquid-nitrogen boil-off, and placed in a Jelight UVO model 42 ozone cleaner for 15 minutes. The samples were then mounted into the vacuum evaporator immediately following the ozone treatment. At a base pressure of 2×10⁻⁶ Torr, a 10-nm adhesive layer of chromium was deposited, onto which a 110-nm-thick film of Au was deposited. Once the system cooled to room temperature, the substrates were removed from the evaporator and stored in a dessicator and cut into approximately 1.0 cm×1.7 cm pieces until used for monolayer deposition.

The monolayer was deposited in the following manner. The gold substrates were chemically cleaned for 15 min in a Jelight UVO model 42 ozone cleaner operating at atmospheric oxygen concentrations. Next, the substrates were immersed into a dilute (0.25 mM) iso-octane solution of monomer for at least 12 hours. The samples were removed from the initiator solution, rinsed thoroughly with chloroform, and blown dry with liquid-nitrogen boil-off. Polymerization experiments were initiated immediately following monomer deposition.

Polymerizations were carried out in a Rayonet photochemical reactor (model RMR-600, Southern New England Ultraviolet Co., Branford, Conn.). The polymerization took place by first immersing the SAM coated substrate into a Schlenk tube with monomer and benzophenone (11.0 mM). The Schlenk tube was purged with argon, degassed by three successive freeze-pump-thaw cycles, and was back-filled with argon prior to irradiation at 350 nm (˜1.6 mW/cm²). The substrates were removed after a specified irradiation time at room temperature, and were then cleaned by Soxhlet extraction with tetrahydrofuran for 10 hours.

Reflection absorption infrared (RAIR) spectra were recorded following deposition of the initiator SAM and polymerizations of Styrene and methyl methacrylate. Infrared spectra were recorded on a Nicolet-670 FTIR spectrometer equipped with a liquid-nitrogen cooled MCT-B detector and a PIKE grazing angle accessory; all spectra were collected at an 80° grazing angle. The sample chamber was purged with nitrogen gas for 20 minutes prior to data acquisition.

X-ray Photoelectron Spectroscopy (XPS) measurements were conducted using a Kratos Axis Ultra X-ray photoelectron spectrometer. Analysis was carried out under ultra-high vacuum conditions (10⁻⁹ torr) using monochromatic Al K (1486.6 eV) excitation. The hemispherical energy analyzer was operated in the hybrid mode with a 300 m×700 m slot selected area aperture. The sample stage was grounded to the spectrometer and the neutralizer was off. Spectra were collected in the constant pass energy (fixed analyzer transmission) mode. Survey spectra were collected using a pass energy of 160 eV with a scan step size of 1 eV. High-resolution spectra were collected with a pass energy of 20 eV and a scan step size of 0.1 eV.

Static contact angles of samples were measured with a CAM Micro Tantec contact angle meter at room temperature. Contact angles were collected and averaged from the measurements at three different spots on each substrate.

The film thickness was obtained with an I-EIIi2000 imaging ellipsometer (Nanofilm Technologie, GmBH). The experiments were performed with 20 mW Nd:YAG laser (532 nm) at an incident angle of 70° for SAMs and 50° for the brushes. The optical constants n (refractive index) and k (extinction coefficient) were measured from bare gold. Refractive indices of 1.46, 1.59 and 1.49 were used for the calculation of initiator SAMs, PS and PMMA films, respectively. The films were considered to be optically transparent and data was collected and averaged over at least five different spots per slide.

Although examples of representative monomers have been presented along with other specific details, it should not be construed as limiting the scope of the invention since it is apparent that various embodiments, modifications, substitutions and exchanges may be performed without departing from the broader spirit and scope of the invention, and it is understood that such variations are intended to be included within the scope of this invention.

A paper detailing the photoinduced polymerization from Dimethylamino-Terminated Self-Assembled Monolayers on Gold is attached hereto as Appendix I, and forms a part of this disclosure, although the invention is limited to this particular embodiment, and in particular is not limited to self-assembled monolayers nor is it limited to gold substrates.

What is claimed is:

1. A method of synthesizing grafted polymer films comprising irradiating an alkylamino initiator tethered to a substrate in the presence of a monomer solution to initiate free radical polymerization to create a polymer that is covalently bonded to the substrate.

2. The method according to claim 1 further comprising irradiating the alkylamino initiator in the presence of a photosensitizer.

3. The method according to claim 2 wherein the photosensitizer comprises benzophenone.

4. The method according to claim 2 wherein the photosensitizer comprises a two-photon absorbing species, such as rose bengal.

5. The method according to claim 1 wherein the substrate is gold.

6. The method according to claim 1 wherein the substrate is silver.

7. The method according to claim 1 wherein the substrate is a thin layer of metal.

8. The method according to claim 7 wherein the substrate is planar.

9. The method according to claim 7 wherein the thin layer of metal is adsorbed onto a support.

10. The method according to claim 1 wherein the substrate is a micron-sized particle.

11. The method according to claim 1 wherein the substrate is a nanometer-sized particle.

12. The method according to claim 1 wherein the substrate is a silicon wafer.

13. The method according to claim 1 wherein the substrate is a glass.

14. The method according to claim 1 wherein the substrate is a sol-gel.

15. The method according to claim 1 wherein the substrate is mica.

16. The method according to claim 1 wherein the substrate is an organic polymer.

17. The method according to claim 1 wherein the alkylamino initiator is of the form: 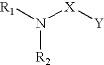
wherein Y consists of either a thiol or disulfide group.
wherein X is selected from the group consisting of(C₁-C₂₀)alkyl, ((CH₂)ₘOCₙH₂ₙ) alkoxy, (C₁-C₂₀)perfluoroalkyl, ((CH₂)OCₙF₂ₙ)perfluoroalkoxy, aryl, or any combination thereof; or a carbonyl functionality, such as an esters, imides, amides and carbamates;
wherein R1 and R2 are of any combination of hydrogen, methyl, (C₁-C₂₀)alkyl, C₁-C₂₀ perfluoroalkyl, amide, imide, ester, carbamate, ((CH₂)ₘOCₙH₂ₙ), (O(CₙH₂ₙ₊₁), or hydroxyl.

18. The method according to claim 1 wherein the substrate consists of silicon oxide surfaces including a silicon wafer, glass, mica, quartz, silica gel, sol-gel and micron or nanometer sized particles of silica

19. The method according to claim 18 wherein the alkylamino initiator is of the form: 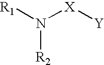
wherein Y is selected from the group consisting of trialkoxysilyl, di methylalkoxysilyl, dimethylchlorosilyl, or trichlorosilyl.
wherein X is selected from the group consisting of (C₁-C₂₀)alkyl, ((CH₂)ₘOCₙH₂ₙ) alkoxy, (C₁-C₂₀)perfluoroalkyl, ((CH₂)OCₙF₂ₙ)perfluoroalkoxy, aryl, or any combination thereof; or a carbonyl functionality, such as an esters, imides, amides and carbamates;
wherein R1 and R2 are of any combination of hydrogen, methyl, (C₁-C₂₀)alkyl, C₁-C₂₀ perfluoroalkyl, amide, imide, ester, carbamate, ((CH₂)ₘOCₙH₂ₙ), (O(CₙH₂ₙ₊₁), or hydroxyl.

20. The method according to claim 1 wherein the substrate consists of an organic polymer film.

21. The method of claim 20 wherein the alkylamino initiator is of the form: 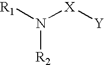
wherein Y is a monomeric unit such as acrylate, methacrylate, or vinyl functional group for incorporation into a polymer prior to photografting;
wherein X is selected from the group consisting of (C₁-C₂₀)alkyl, ((CH₂)ₘOCₙH₂ₙ) alkoxy, (C₁-C₂₀)perfluoroalkyl, ((CH₂)OCₙF₂ₙ)perfluoroalkoxy, aryl, or any combination thereof; or a carbonyl functionality, such as an esters, imides, amides and carbamates;
wherein R1 and R2 are of any combination of hydrogen, methyl, ((CH₂)ₘOCₙH₂ₙ), (C₁-C₂₀)alkyl, C₁-C₂₀ perfluoroalkyl, amide, imide, ester, carbamate, (O(CₙH₂ₙ₊₁), or hydroxyl.

22. The method of claim 20 wherein the alkylamino initiator is of the form: 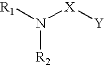
wherein Y consists of a functional group that is capable of bonding to active functional groups on a preformed polymer, such as, but not limited to, hydroxyl, carboxylic acid, or primary amines;
wherein X is selected from the group consisting of (C₁-C₂₀)alkyl, ((CH₂)ₘOCₙH₂ₙ) alkoxy, (C₁-C₂₀)perfluoroalkyl, ((CH₂)OCₙF₂ₙ)perfluoroalkoxy, aryl, or any combination thereof; or a carbonyl functionality, such as an esters, imides, amides and carbamates;
wherein R1 and R2 are of any combination of hydrogen, methyl, (C₁-C₂₀)alkyl, C₁-C₂₀ perfluoroalkyl, amide, imide, ester, carbamate, ((CH₂)ₘOCₙH₂ₙ), (O(CₙH₂ₙ₊₁), or hydroxyl.

23. The method according to claim 1 wherein the substrate consists of a Cd/Se crystal, microparticle, or nanoparticle.

24. The method of claim 23 wherein the alkylamino initiator is of the form: 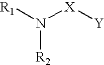
wherein Y is selected from the group comprising a tri-alkyl phosphine oxide or a triaryl phosphine oxide, or any combination thereof;
wherein X is selected from the group consisting of(C₁-C₂₀)alkyl, ((CH₂)ₘOCₙH₂ₙ) alkoxy, (C₁-C₂₀)perfluoroalkyl, ((CH₂)OCₙF₂ₙ)perfluoroalkoxy, aryl, or any combination thereof; or a carbonyl functionality, such as an esters, imides, amides and carbamates;
wherein R1 and R2 are of any combination of hydrogen, methyl, (C₁-C₂₀)alkyl, C₁-C₂₀ perfluoroalkyl, amide, imide, ester, carbamate, ((CH₂)ₘOCₙH₂ₙ), (O(CₙH₂ₙ₊₁), or hydroxyl.

25. The method according to claim 1 wherein the substrate consists of a biopolymer or biomembrane.

26. The method according to claim 25 wherein the alkylamino initiator is of the form: 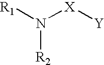
wherein Y is selected from the group comprising a phosphate, a hydroxyl, or carboxylate group that is capable of bonding to the membrane or biopolymer;
wherein X is selected from the group consisting of (C₁-C₂₀)alkyl, ((CH₂)ₘOCₙH₂ₙ) alkoxy, (C₁-C₂₀)perfluoroalkyl, ((CH₂)OCₙF₂ₙ)perfluoroalkoxy, aryl, or any combination thereof; or a carbonyl functionality, such as an esters, imides, amides and carbamates;
wherein R1 and R2 are of any combination of hydrogen, methyl, (C₁-C₂₀)alkyl, C₁-C₂₀ perfluoroalkyl, amide, imide, ester, carbamate, ((CH₂)ₘOCₙH₂ₙ), (O(CₙH₂ₙ₊₁), or hydroxyl.

27. The method according to claim 1 wherein the substrate consists of a hyperbranched polymer, such as a dendrimer.

28. The method according to claim 27 wherein the alkylamino initiator is of the form: 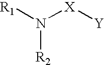
wherein Y consists of a functional group that is capable of bonding to the periphery or interior of a hyperbranched polymer prior to photografting;
wherein X is selected from the group consisting of (C₁-C₂₀)alkyl, ((CH₂)ₘOCₙH₂ₙ) alkoxy, (C₁-C₂₀)perfluoroalkyl, ((CH₂)OCₙF₂ₙ)perfluoroalkoxy, aryl, or any combination thereof; or a carbonyl functionality, such as an esters, imides, amides and carbamates;
wherein R1 and R2 are of any combination of hydrogen, methyl, (C₁-C₂₀)alkyl, C₁-C₂₀ perfluoroalkyl, amide, imide, ester, carbamate, ((CH₂)ₘOCₙH₂ₙ), (O(CₙH₂ₙ₊₁), or hydroxyl.
